(19) United States
(12) Patent Application Publication
(10) Pub. No.: US 2011/0242727 A1
(43) Pub. Date: Oct. 6, 2011

(54) CAPACITOR

(76) Inventors: Wan-Don KIM, Yongin-si (KR); Beom-Seok Kim, Suwon-si (KR); Jong-Cheol Lee, Seoul (KR); Kyu-Ho Cho, Hwaseong-si (KR); Jin-Yong Kim, Seoul (KR); Oh-Seong Kwon, Hwaseong-si (KR); Yong-Suk Tak, Seoul (KR)

(21) Appl. No.: 13/076,950

(22) Filed: Mar. 31, 2011

(30) Foreign Application Priority Data
Apr. 2, 2010 (KR) 10-2010-0030552

(51) Int. Cl. H01G 4/06

(52) U.S. Cl. 361/311

(57) ABSTRACT

A capacitor may include a lower electrode structure, a dielectric layer and an upper electrode structure. The lower electrode structure may include a first lower pattern, a first deformation-preventing layer pattern and a second lower pattern. The first lower pattern may have a cylindrical shape. The first deformation-preventing layer pattern may be formed on an inner surface of the first lower pattern. The second lower pattern may be formed on the first deformation-preventing layer pattern. The dielectric layer may be formed on the lower electrode structure. The upper electrode structure may be formed on the dielectric layer. Thus, the capacitor may have a high capacitance and improved electrical characteristics.

This application claims priority under 35 USC §119 to Korean Patent Application No. 2010-30552, filed on Apr. 2, 2010 in the Korean Intellectual Property Office (KIPO), the contents of which are herein incorporated by reference in their entirety.

### BACKGROUND

1. Field

Example embodiments relate to a capacitor and a method of forming the same. More particularly, example embodiments relate to a capacitor having a high capacitance, and a method of forming the capacitor.

2. Description of the Related Art

As an area of a cell in a semiconductor device becomes reduced by a high integration of the semiconductor device, it becomes desirable to form a capacitor having a high capacitance in the small area of the cell.

### SUMMARY

According to an example embodiments, there is provided a a capacitor including a lower electrode structure including a first lower pattern having a hollow cylindrical shape, a first deformation-preventing layer pattern formed on an inner surface of the first lower pattern and a second lower pattern formed on the first deformation-preventing layer pattern, a dielectric layer formed on the lower electrode structure, and an upper electrode structure formed on the dielectric layer.

The first lower pattern and the second lower pattern may include at least one of a noble metal, conductive noble oxide and conductive perovskite-type oxide.

The first lower pattern and the second lower pattern may include at least one of Pt, Ru, Ir, PtO, RuO₂, IrO₂, SRO(SrRuO₃), BSRO((Ba,Sr)RuO₃), CRO(CaRuO₃) and LSCO.

The first deformation-preventing layer pattern may have a thickness that is less than that of the dielectric layer.

The first deformation-preventing layer pattern may have a thickness of about 3 Å to about 20 Å.

The first deformation-preventing layer pattern may include an insulating metal oxide or an insulating silicon oxide.

The first deformation-preventing layer pattern may include at least one of Ta₂O₅, Ta₂O₅N, Al₂O₅, HfO₂, ZrO₂, TiO₂ and SrO.

The upper electrode structure may include a first upper layer, a second deformation-preventing layer formed on the first upper layer, and a second upper layer formed on the second deformation-preventing layer.

The lower electrode structure may further include a buried layer pattern formed on the second lower pattern.

The dielectric layer may include at least one of a metal oxide and a non-conductive perovskite-type oxide.

The dielectric layer may include at least one of Ta₂O₅, Ta₂O₅N, Al₂O₅, HfO₂, ZrO₂, TiO₂, (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃ or Bi₄Ti₃O₁₂.

According to an example embodiment, there is provided a method of forming a capacitor, the method including forming a mold layer having an opening on a substrate, forming a lower electrode structure in the opening of the mold layer, the lower electrode structure including a first lower pattern having a hollow cylindrical shape, a first deformation-preventing layer pattern formed on an inner surface of the first lower pattern and a second lower pattern formed on the first deformation-preventing layer pattern, removing the mold layer, forming a dielectric layer on the lower electrode structure, and forming an upper electrode structure on the dielectric layer.

The forming of the lower electrode structure may include forming a first lower layer on an inner surface of the opening and an upper surface of the mold layer, forming a first deformation-preventing layer on the first lower layer, forming a second lower layer on the first deformation-preventing layer to fill up the opening, and removing the first lower layer, the first deformation-preventing layer and the second lower layer to expose the upper surface of the mold layer.

The forming of the lower electrode structure may further include forming a buried layer pattern on the second lower pattern.

The forming the lower electrode structure may include forming a first lower layer on an inner surface of the opening and an upper surface of the mold layer, forming a first deformation-preventing layer on the first lower layer, forming a second lower layer on the first deformation-preventing layer, forming a buried layer on the second lower layer, and removing the first lower layer, the first deformation-preventing layer, the second lower layer and the buried layer to expose the upper surface of the mold layer.

The first lower pattern and the second lower pattern may include at least one of a noble metal, conductive noble oxide and conductive perovskite-type oxide.

The first deformation-preventing layer pattern may include an insulating metal oxide.

The method may further include thermally or plasma treating the dielectric layer.

The forming of the upper electrode structure may include forming a first upper layer on the dielectric layer, forming a second deformation-preventing layer on the first upper layer, and forming a second upper layer on the second deformation-preventing layer.

The first upper layer may include a material that is substantially the same as that of the first lower layer pattern, the second deformation-preventing layer includes a material that is substantially the same as that of the first deformation-preventing layer pattern, and the second upper layer includes a material that is substantially the same as that of the second lower layer pattern

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a cross-sectional view relating to a capacitor in accordance with some example embodiments;

FIGS. 2A to 2F illustrate cross-sectional views relating to a method of forming the capacitor in FIG. 1;

FIG. 3 illustrates a cross-sectional view relating to a DRAM device including the capacitor in FIG. 1;

FIGS. 4A to 4C illustrate cross-sectional views relating to a method of manufacturing the DRAM device in FIG. 3;

FIG. 5 illustrates a cross-sectional view relating to a capacitor in accordance with some example embodiments;

FIG. 6 illustrates a cross-sectional view relating to a DRAM device including the capacitor in FIG. 5;

FIG. 7 illustrates a cross-sectional view relating to a capacitor in accordance with some example embodiments;

FIGS. 8A to 8D illustrate cross-sectional views relating to a method of forming the capacitor in FIG. 7;

FIG. 9 illustrates a cross-sectional view relating to a DRAM device including the capacitor in FIG. 7;

FIG. 10 illustrates a cross-sectional view relating to a capacitor in accordance with some example embodiments;

FIG. 11 illustrates a cross-sectional view relating to a method of forming the capacitor in FIG. 10;

FIG. 12 illustrates a cross-sectional view relating to a DRAM device including the capacitor in FIG. 10; and

FIGS. 13 to 15 illustrate block diagrams relating to memory systems in accordance with some example embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. The term “etc.” following a list of items indicates that any and all combinations of one or more of the associated listed items and/or similar items may be included.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

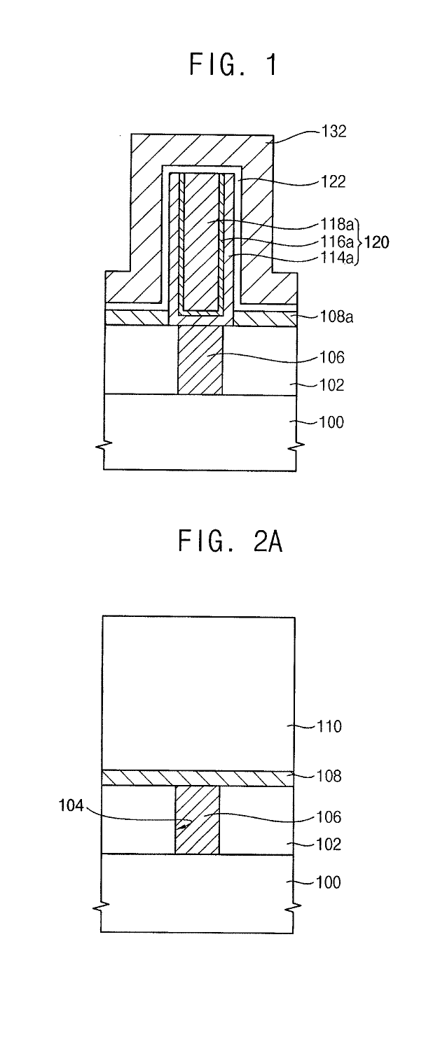

FIG. 1 illustrates a cross-sectional view relating to a capacitor in accordance with some example embodiments.

Referring to FIG. 1, an insulating interlayer 102 may be formed on an upper surface of a semiconductor substrate 100. A contact plug 106 may be formed through the insulating interlayer 102. The contact plug 106 may have a lower surface configured to make contact with the upper surface of the semiconductor substrate 100. The contact plug 106 may have an upper surface configured to make contact with the capacitor. In some example embodiments, the contact plug 106 may be configured to be connected with impurity regions (not shown) in the semiconductor substrate 100.

In some example embodiments, the contact plug 106 may include a metal. For example, the contact plug 106 may include a heat-resistant metal or metal material such as Ti, TiN, W, WN, Ta, TaN, ZrN, HfN, TiAlN, TiSiN, TaAlN, TaSiN, etc. The contact plug 106 may include a noble metal such as Ru, Ir, Pt, etc. The contact plug 106 may include at least one of above-mentioned metals or metal materials. A lower pattern of the capacitor making contact with the contact plug 106 may include a metal. Therefore, the contact plug 106 may include a metal having a strong adhesive characteristic with respect to the lower pattern.

An etch stop layer pattern 108a may be formed on the insulating interlayer 102. In some example embodiments, the etch stop layer pattern 108a may have an opening configured to expose the upper surface of the contact plug 106.

A lower electrode structure 120 may be formed on the upper surface of the contact plug 106. In some example embodiments, the lower electrode structure 120 may include a first lower pattern 114a, a first deformation-preventing layer pattern 116a and a second lower pattern 118a. The first lower pattern 114a may include a hollow cylindrical-shaped portion and a closed lower end, and the term “having a cylindrical shape” may include such a configuration. The first deformation-preventing layer pattern 116a may be formed at an inner surface of the first lower pattern 114a. The second lower pattern 118a may be formed on the first deformation-preventing layer pattern 116a to fill up the first lower pattern 114a. Thus, the lower electrode structure 120 may have a pillar shape. An outer surface of the first lower pattern 114a may be exposed. Upper surfaces of the first lower pattern 114a, the first deformation-preventing layer pattern 116a and the second lower pattern 118a may be exposed.

In some example embodiments, the first lower pattern 114a and the second lower pattern 118a may serve as a lower electrode of the capacitor. The first deformation-preventing layer pattern 116a may be configured to be interposed between the first lower pattern 114a and the second lower pattern 118a.

In some example embodiments, the first lower pattern 114a and the second lower pattern 118a may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO (SrRuO₃), BSRO ((Ba,Sr)RuO₃), CRO (CaRuO₃), LSCO ((La,Sr)CoO₃), etc. The first lower pattern 114a and the second lower pattern 118a may include substantially the same material. Alternatively, the first lower pattern 114a and the second lower pattern 118a may include different materials. The first lower pattern 114a and the second lower pattern 118a may include a material having a high oxidation-resistivity and a high work function. Therefore, a formation of an undesired dielectric layer on the first lower pattern 114a and the second lower pattern 118a may be suppressed. As a result, the first lower pattern 114a and the second lower pattern 118a may provide the capacitor with a high capacitance.

In some example embodiments, the first deformation-preventing layer pattern 116a may suppress a grain growth of the first lower pattern 114a and the second lower pattern 118a when a heat may be applied to the first lower pattern 114a and the second lower pattern 118a. Further, the first deformation-preventing layer pattern 116a may suppress stresses applied to the first lower pattern 114a and the second lower pattern 118a.

If a heat having a temperature of not less than about 400° C. were to be applied to a first lower pattern and a second lower pattern in a structure not having the first deformation-preventing layer pattern, grain growth and an agglomeration may be generated in such a first lower pattern and the second lower pattern according to a thermal budget. When the grain growth is be generated in such a first lower pattern and the second lower pattern, a dielectric layer on the first lower pattern and the second lower pattern may be damaged, so that a leakage current may flow through the dielectric layer. Further, the first lower pattern and the second lower pattern may lean or collapse. However, according to some example embodiments, the first deformation-preventing layer pattern 116a between the first lower pattern 114a and the second lower pattern 118a may suppress the grain growth of the first lower pattern 114a and the second lower pattern 118a, so that deformations and electrical characteristic changes of the first lower pattern 114a and the second lower pattern 118a may be suppressed.

In some example embodiments, the first deformation-preventing layer pattern 116a may include metal oxide, silicon oxide, etc. The metal oxide may include Ta₂O₅, Ta₂O₅N, Al₂O₅, HfO₂, ZrO₂, TiO₂, SrO, etc. These may be used alone or in a combination thereof. In order to suppress the grain growth of the first lower pattern 114a and the second lower pattern 118a, the metal oxide may have extension stresses. Thus, the metal oxide may include HfO₂ or ZrO₂.

If the first deformation-preventing layer pattern 116a were to have have a thickness of less than about 3 Å, it may be difficult to suppress the grain growth of the first lower pattern 114a and the second lower pattern 118a. On the other hand, if the first deformation-preventing layer pattern 116a were to have a thickness of greater than about 20 Å, it may be difficult to form the second lower pattern 118a, because the second lower pattern 118a may have a narrow width. Thus, according to some example embodiments, the first deformation-preventing layer pattern 116a may have a thickness of about 3 Å to about 20 Å, preferably about 5 Å. Here, the capacitor with the first deformation-preventing layer pattern 116a may have a capacitance that is substantially the same as that of a capacitor without the first deformation-preventing layer pattern 116a. That is, the first deformation-preventing layer pattern 116a may act as to reduce the capacitance of the capacitor.

The dielectric layer 122 may be formed on the lower electrode structure 120 and the etch stop layer pattern 108a. Particularly, the dielectric layer 122 may be formed on the outer surface of the first lower pattern 114a, the upper surfaces of the first lower pattern 114a, the second lower pattern 118a and the first deformation-preventing layer pattern 116a, and the upper surface of the etch stop layer pattern 108a. In some example embodiments, the dielectric layer 122 may include a metal oxide, non-conductive perovskite-type oxide, etc. For example, the metal oxide may include Ta₂O₅, Ta₂O₅N, Al₂O₅, HfO₂, ZrO₂, TiO₂, etc. The non-conductive perovskite-type oxide may include (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃, Bi₄Ti₃O₁₂, etc. These may be used alone or in a combination thereof.

If the dielectric layer 122 were to have a thickness of less than about 50 Å, a leakage current through the dielectric layer 122 could be increased. On the other hand, if the dielectric layer 122 were to have a thickness of greater than about 150 Å, the capacitor may not be provided with the desired capacitance. Thus, according to some example embodiments, the dielectric layer 122 may have a thickness of about 50 Å to about 150 Å. The thickness of the dielectric layer 122 may be greater than that of the first deformation-preventing layer pattern 116a.

An upper electrode 132 may be formed on the dielectric layer 122. In some example embodiments, the upper electrode 132 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc.

In some example embodiments, the upper electrode 132 may include a material that is substantially the same as that of the first lower pattern 114a and the second lower pattern 118a. Alternatively, the upper electrode 132 may include a material different from that of the first lower pattern 114a and the second lower pattern 118a.

According to this example embodiment, the capacitor may include the dielectric layer having a high dielectric constant, the lower electrode structure having a high work function, and the upper electrode having a high work function. Further, the first deformation-preventing layer pattern of the lower electrode structure may suppress the grain growth of the first lower pattern and the second lower pattern. Thus, the capacitor may have a low leakage current and a high capacitance.

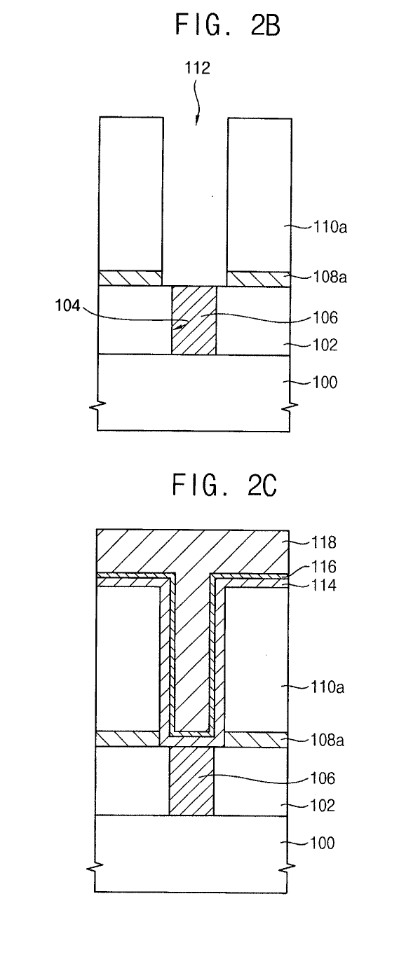

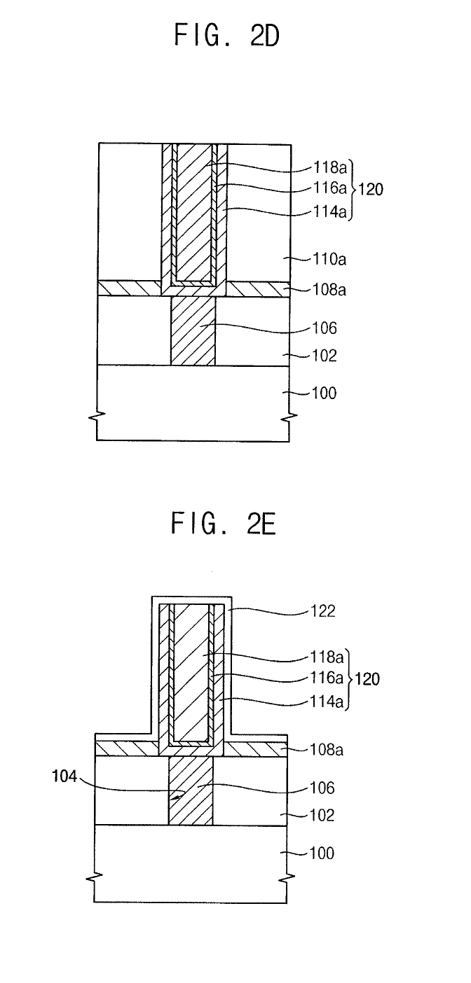

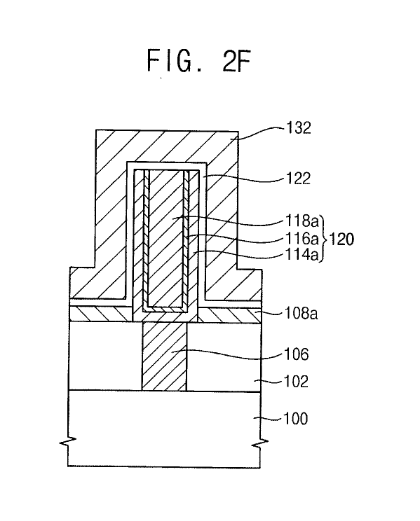

FIGS. 2A to 2F illustrate cross-sectional views relating to a method of forming the capacitor in FIG. 1.

Referring to FIG. 2A, an insulating interlayer 102 may be formed on a semiconductor substrate 100. In some example embodiments, before forming the insulating interlayer 102, a transistor (not shown) and a metal wiring (not shown) may be formed on the semiconductor substrate 100.

The insulating interlayer 102 may be etched to form a contact hole 104 configured to expose an upper surface of the semiconductor substrate 100. In some example embodiments, the exposed upper surface of the semiconductor substrate 100 may correspond to an impurity region (not shown).

The contact hole 104 may be filled with a conductive layer (not shown). The conductive layer may be planarized until an upper surface of the insulating interlayer 102 to form a contact plug 106. In some example embodiments, the contact plug 106 may include a metal. For example, the contact plug 106 may include a heat-resistant metal or metal material such as Ti, TiN, W, WN, Ta, TaN, ZrN, HfN, TiAlN, TiSiN, TaAlN, TaSiN, etc. The contact plug 106 may include a noble metal such as Ru, Ir, Pt, etc. The contact plug 106 may include at least one of above-mentioned metals or metal materials. For example, the contact plug 106 may include the heat-resistant metal or metal material and the noble metal sequentially stacked.

An etch stop layer 108 may be formed on the insulating interlayer 102 and the contact plug 106. In some example embodiments, the etch stop layer 108 may include silicon nitride formed by a chemical vapor deposition (CVD) process.

A mold layer 110 may be formed on the etch stop layer 108. In some example embodiments, the mold layer 110 may serve as to form a lower electrode. Thus, the mold layer 110 may have a thickness substantially equal to or higher than that of the lower electrode. The mold layer 110 may include a material having an etching selectivity with respect to the etch stop layer 108. The mold layer 108 may include a material readily removed by a wet etching process. For example, the mold layer 110 may include silicon oxide. Particularly, the mold layer 110 may include BPSG (boron-phospho-silicate glass), TOSZ (Tozen Silazene, a polysilazane), HDP (a high density plasma oxide), PE-TEOS (plasma-enhanced tetraethyl ortho silicate), etc.

Referring to FIG. 2B, the mold layer 110 and the etch stop layer 108 may be etched to form an opening 112 configured to expose an upper surface of the contact plug, thereby forming a mold layer pattern 110a and an etch stop layer pattern 108a.

Referring to FIG. 2C, a first conductive layer 114 may be formed on an inner surface of the opening 112 and an upper surface of the mold layer pattern 110a. In some example embodiments, the first conductive layer 114 may be converted into a first lower pattern by following processes. The first conductive layer 114 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof.

In some example embodiments, the first conductive layer 114 may be formed by an atomic layer deposition (ALD) process, a CVD process, a physical vapor deposition (PVD) process, etc. In order to provide the first conductive layer 114 with good step coverage, the first conductive layer 114 may be formed by the ALD process.

A first deformation-preventing layer 116 may be formed on the first conductive layer 114. In some example embodiments, the first deformation-preventing layer 116 may include metal oxide, silicon oxide, etc. The metal oxide may include Ta₂O₅, Ta₂O₅N, Al₂O₅, HfO₂, ZrO₂, TiO₂, SrO, etc. These may be used alone or in a combination thereof. The first deformation-preventing layer 116 may have a thickness of about 3 Å to about 20 Å. In order to provide the first deformation-preventing layer 116 with good step coverage and a uniform thin thickness, the first deformation-preventing layer 116 may be formed by an ALD process or a CVD process.

A second conductive layer 118 may be formed on the first deformation-preventing layer 116 to fill up the opening 112. In some example embodiments, the second conductive layer 118 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof. The second conductive layer 118 may be formed by an ALD process, a CVD process, a PVD process, etc. In order to provide the second conductive layer 118 with good step coverage, the second conductive layer 118 may be formed by the ALD process.

Referring to FIG. 2D, an upper portion of the first conductive layer 114, the first deformation-preventing layer 116 and the second conductive layer 118 may be removed until an upper surface of the mold layer pattern 110a is exposed to form a lower electrode structure 120. The lower electrode structure 120 may include a first lower pattern 114a, a first deformation-preventing layer pattern 116a and a second lower pattern 118a. The first lower pattern 114a may include a hollow cylindrical-shaped portion and a closed lower end. The first deformation-preventing layer pattern 116a may be formed on an inner surface of the first lower pattern 114a. The second lower pattern 118a may be formed on the first deformation-preventing layer pattern 116a to fill up the opening 112 of the first lower pattern 114a. Thus, the lower electrode structure 120 may have a pillar shape. In some example embodiments, the first conductive layer 114, the first deformation-preventing layer 116 and the second conductive layer 118 may be removed by a chemical mechanical polishing (CMP) process, an etch-back process, etc.

Referring to FIG. 2E, the mold layer pattern 110a may be removed to expose a surface of the lower electrode structure 120. In some example embodiments, the mold layer pattern 110a may be removed by a wet etching process to prevent the lower electrode structure 120 from being damaged by plasma. Particularly, an outer surface of the first lower pattern 114a may be exposed. Upper surfaces of the first lower pattern 114a, the first deformation-preventing layer pattern 116a and the second lower pattern 118a may be exposed.

A dielectric layer 122 may be formed on the lower electrode structure 120 and the etch stop layer pattern 108a. In some example embodiments, the dielectric layer 122 may include a metal oxide, a non-conductive perovskite-type oxide, etc. For example, the metal oxide may include Ta₂O₅, Ta₂O₅N, Al₂O₅, HfO₂, ZrO₂, TiO₂, etc. The non-conductive perovskite-type oxide may include (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃, Bi₄Ti₃O₁₂, etc. These may be used alone or in a combination thereof. Further, the dielectric layer 122 may have a thickness of about 50 Å to about 150 Å. Thus, the thickness of the dielectric layer 122 may be greater than that of the first deformation-preventing layer pattern 116a. The dielectric layer 122 may be formed by an ALD process, a PVD process, etc. In order to provide the dielectric layer 122 with good step coverage, the dielectric layer 122 may be formed by the ALD process.

In some example embodiments, after forming the dielectric layer 122, the dielectric layer 122 may be thermally treated additionally to improve characteristics of the dielectric layer 122. The thermal treatment process may provide the dielectric layer 122 with a high dielectric constant. The thermal treatment process may be performed at a temperature of above about 600° C.

Although the dielectric layer 122 may be thermally treated, the grain growth of the first lower pattern 114a and the second lower pattern 118a may be suppressed, because the first deformation-preventing layer pattern 116a may suppress the grain growth and the agglomeration of the first lower pattern 114a and the second lower pattern 118a. Thus, physical damage to the dielectric layer 122 from the first lower pattern 114a and the second lower pattern 118a may be remarkably reduced, so that a leakage current through the dielectric layer 122 may be decreased. As a result, the capacitor may have the dielectric layer 122 having a high dielectric constant and a low leakage current.

Referring to FIG. 2F, an upper electrode 132 may be formed on the dielectric layer 122. In some example embodiments, the upper electrode 132 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof.

In some example embodiments, the upper electrode 132 may be formed by an ALD process, a CVD process, a PVD process, etc. In order to provide the upper electrode 132 with good step coverage, the upper electrode 132 may be formed by the ALD process.

Polysilicon may be generally used for an upper electrode and a lower electrode of a capacitor. However, when a metal oxide is used for a dielectric layer of the capacitor, the polysilicon may not be used for the upper electrode and the lower electrode of the capacitor, because the metal oxide and the polysilicon may chemically react with each other to form an additional dielectric layer having a low dielectric constant between the electrode and the dielectric layer. The additional dielectric layer may decrease a capacitance of the capacitor and also increase a leakage current of the capacitor, so that the capacitor may have bad electrical characteristics.

In contrast, according to this example embodiment, when the dielectric layer 122 includes the metal oxide and the lower electrode structure 120 and the upper electrode 132 includes the metal, a work function difference between the dielectric layer 122 and the electrodes 120 and 132 may be increased to form a leakage current barrier capable of reducing a leakage current. Particularly, when the electrodes 120 and 132 include a noble metal having a high work function and a strong oxidation resistivity, an interface layer caused by an oxidation may not be formed, so that a capacitance of the capacitor may be still maintained. Additionally, the first deformation-preventing layer pattern 116a may prevent the thermal budget from being applied to the lower electrode structure 120, so that the lower electrode structure 120 may not be physically deformed or electrical characteristics of the capacitor may not be reduced.

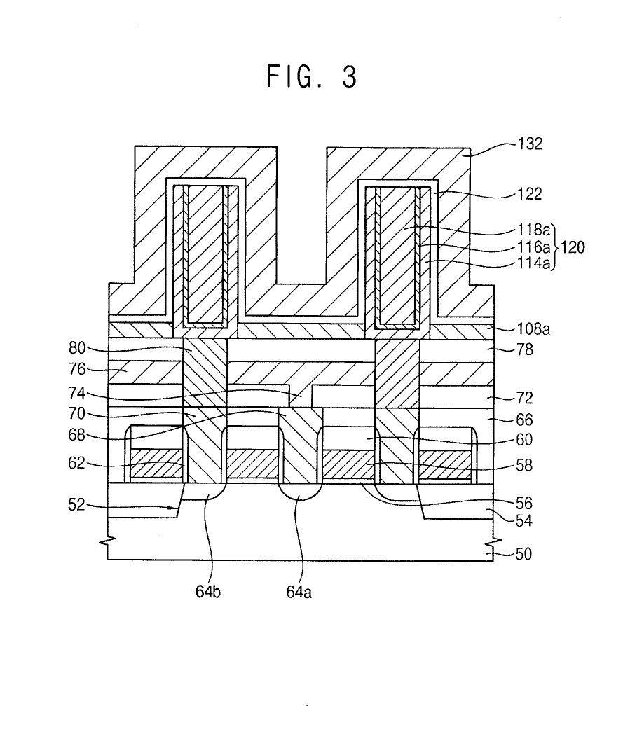

FIG. 3 illustrates a cross-sectional view relating to a DRAM device including the capacitor in FIG. 1.

Referring to FIG. 3, isolation layer patterns 54 may be formed in a semiconductor substrate 50 to define an active region and a field region of the semiconductor substrate 50. In some example embodiments, a MOS transistor may be formed on the semiconductor substrate 50. The MOS transistor may function as a switching element for selecting a cell of the DRAM device. The MOS transistor may include a gate electrode 58 commonly used as a partial of a word line. The gate electrode 58 may have a linear shape extending in a first direction. A hard mask pattern 60 may be formed on the gate electrode 58. A spacer 62 may be formed on sidewalls of the gate electrode 58 and the hard mask pattern 60.

A first insulating interlayer 66 may cover the MOS transistor. A first contact pad 68 and a second contact pad 70 may be formed through the first insulating interlayer 66. The first contact pad 68 and the second contact pad 70 may make contact with a first impurity region 64a and a second impurity region 64b of the MOS transistor, respectively.

A second insulating interlayer 72 may be formed on the first insulating interlayer 66. A bit line contact 74 may be formed through the second insulating interlayer 72. The bit line contact 74 may make contact with the first contact pad 64a. A bit line 76 may make contact with the bit line contact 74. The bit line 76 may extend in a second direction substantially perpendicular to the first direction. A hard mask pattern (not shown) may be formed on the bit line 76. A spacer (not shown) may be formed on a sidewall of the bit line 76.

A third insulating interlayer 78 may be formed on the second insulating interlayer 72 to cover the bit line 76. A storage node contact 80 may be formed through the third insulating interlayer 78 and the second insulating interlayer 72. The storage node contact 80 may make contact with the second contact pad 70. In some example embodiments, the storage node contact 80 may include a material that is substantially the same as that of the contact plug 106 in FIG. 1.

A capacitor that is substantially the same as the capacitor in FIG. 1 may be formed on the storage node contact 80. In some example embodiments, an etch stop layer pattern 108a may be formed on the third insulating interlayer 78. The capacitor may make contact with the storage node contact 80. The capacitor may include a lower electrode structure 120 having a first lower pattern 114a, a first deformation-preventing layer pattern 116a and a second lower pattern 118a. A dielectric layer 122 may be formed on the lower electrode structure 120. An upper electrode 132 may be formed on the dielectric layer 122.

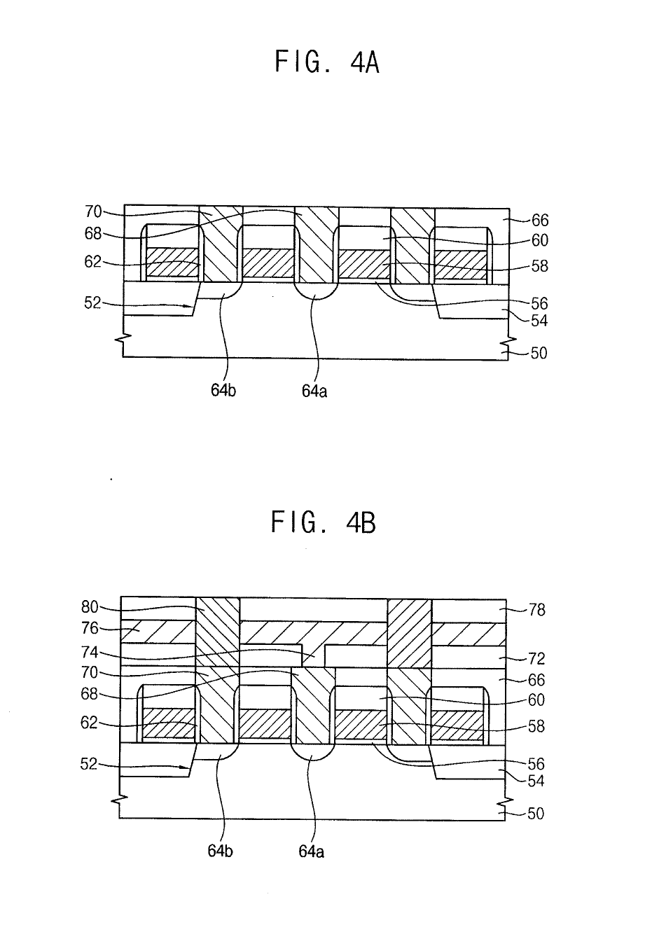

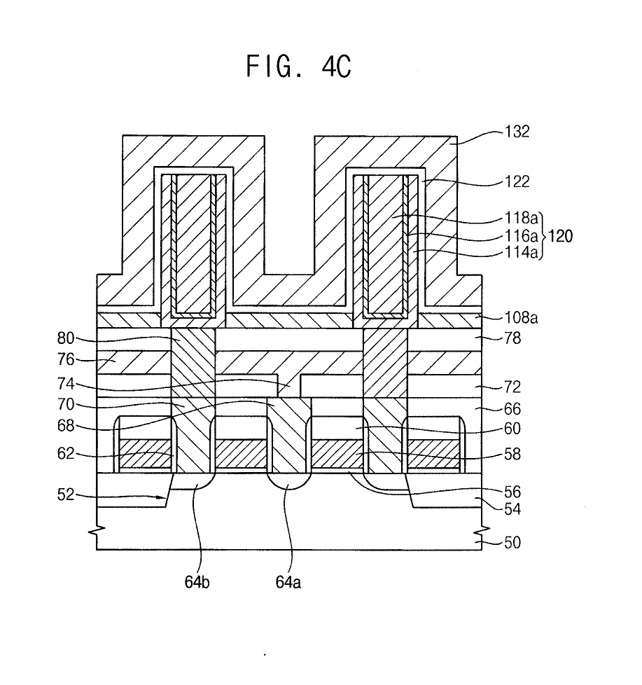

FIGS. 4A to 4C illustrate cross-sectional views relating to a method of manufacturing the DRAM device in FIG. 3.

Referring to FIG. 4A, a pad oxide layer (not shown) and a silicon nitride layer (not shown) may be sequentially formed on a semiconductor substrate 50. A photoresist pattern (not shown) may be formed on the silicon nitride layer. The silicon nitride layer and the pad oxide layer may be etched using the photoresist pattern as an etch mask to form a first hard mask pattern (not shown) including a pad oxide layer pattern (not shown) and a silicon nitride layer pattern (not shown).

The semiconductor substrate 50 may be etched using the first hard mask pattern as an etch mask to form a trench 52. A silicon oxide layer (not shown) may be formed on the semiconductor substrate 50 to fill up the trench 52. The silicon oxide layer may be planarized by a CMP process or an etch-back process to expose an upper surface of the semiconductor substrate 50 and to form an isolation layer pattern 54. The isolation layer pattern 54 may define an active region and a field region of the semiconductor substrate 50.

A gate oxide layer 56 may be formed on the semiconductor substrate 50. A gate structure including a gate electrode 58 and a second hard mask pattern 60 may be formed on the gate oxide layer 56. In some example embodiments, the gate electrode 58 may be a portion of a word line. The gate electrode 58 may extend in a first direction.

A spacer 62 may be formed on a sidewall of the gate structure. In some example embodiments, the spacer 62 may include silicon nitride. Impurities may be implanted into the semiconductor substrate 50 using the gate structure and the spacer 62 as an ion implantation mask to form a first impurity region 64a and a second impurity region 64b, thereby forming a MOS transistor.

A first insulating interlayer 66 may cover the gate structure. A first contact pad 68 and a second contact pad 70 may be formed through the first insulating interlayer 66. The first contact pad 68 and the second contact pad 70 may make contact with the first impurity region 64a and the second impurity region 64b, respectively.

Referring to FIG. 4B, a second insulating interlayer 72 may be formed on the first insulating interlayer 66. A bit line contact 74 may be formed through the second insulating interlayer 72. The bit line contact 74 may make contact with the first contact pad 68. Thus, the bit line contact 74 may be electrically connected with the first impurity region 64a via the first contact pad 68. A bit line 76 may be formed on the second insulating interlayer 72 and the bit line contact 74. In some example embodiments, the bit line contact 74 and the bit line 76 may be formed simultaneously with each other by one deposition process and one patterning process. The bit line 76 may extend in a second direction substantially perpendicular to the first direction. A spacer (not shown) may be formed on a sidewall of the bit line 76.

A third insulating interlayer 78 may be formed on the second insulating interlayer 72 to cover the bit line 76. In some example embodiments, the third insulating interlayer 78 may include silicon oxide formed by a CVD process.

The third insulating interlayer 78 and the second insulating interlayer 72 may be etched to form a contact hole (not shown). The contact hole may be filled with a conductive layer. The conductive layer may be planarized to form a storage node contact 80. The storage node contact 80 may be electrically connected with the second impurity region 64b via the second contact pad 70. In some example embodiments, the storage node contact 80 may include a material substantially the same as that of the contact plug 106 in FIG. 1.

Referring to FIG. 4C, an etch stop layer pattern 108a and a capacitor may be formed on the third insulating interlayer 78. The capacitor may include a lower electrode structure 120, a dielectric layer 122 and an upper electrode 132. The lower electrode structure 120 may include a first lower pattern 114a, a first deformation-preventing layer pattern 116a and a second lower pattern 118a. In some example embodiments, the capacitor may be formed by processes substantially the same as those illustrated with respect to FIGS. 2A to 2F.

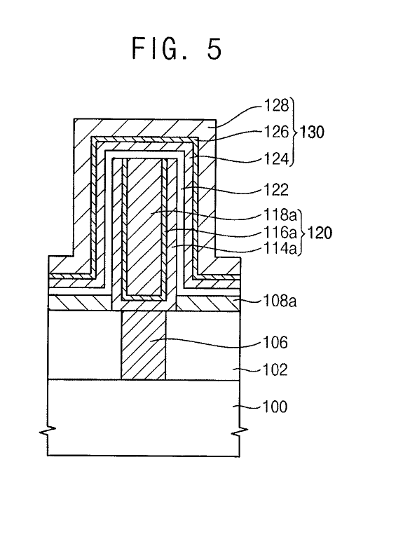

FIG. 5 illustrates a cross-sectional view relating to a capacitor in accordance with some example embodiments.

Referring to FIG. 5, an insulating interlayer 102 may be formed on an upper surface of a semiconductor substrate 100. A contact plug 106 may be formed through the insulating interlayer 102. The contact plug 106 may have a lower surface configured to make contact with the upper surface of the semiconductor substrate 100. An etch stop layer pattern 108a may be formed on the insulating interlayer 102. In some example embodiments, the etch stop layer pattern 108a may have an opening configured to expose the upper surface of the contact plug 106.

A lower electrode structure 120 may be formed on the upper surface of the contact plug 106. In some example embodiments, the lower electrode structure 120 may include a first lower pattern 114a, a first deformation-preventing layer pattern 116a and a second lower pattern 118a. The first lower pattern 114a may include a hollow cylindrical-shaped portion and a closed lower end. The first deformation-preventing layer pattern 116a may be formed an inner surface of the first lower pattern 114a. The second lower pattern 118a may be formed on the first deformation-preventing layer pattern 116a to fill up the first lower pattern 114a. The lower electrode structure 120 may be substantially the same as the lower electrode structure 120 in FIG. 1.

A dielectric layer 122 may be formed on the lower electrode structure 120 and the etch stop layer pattern 108a. In some example embodiments, the dielectric layer 122 may include a metal oxide, a non-conductive perovskite-type oxide, etc. For example, the metal oxide may include Ta₂O₅, Ta₂O₅N, Al₂O₅, HfO₂, ZrO₂, TiO₂, etc. The non-conductive perovskite-type oxide may include (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃, Bi₄Ti₃O₁₂, etc. These may be used alone or in a combination thereof.

An upper electrode structure 130 may be formed on the dielectric layer 122. The upper electrode structure 130 may include a first upper layer 124, a second deformation-preventing layer 126 and a second upper layer 128. In some example embodiments, the first upper layer 124 and the second upper layer 128 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. The first upper layer 124 and the second upper layer 128 may include substantially the same material. Alternatively, the first upper layer 124 and the second upper layer 128 may include different materials.

For example, the first upper layer 124 and the second upper layer 128 may include a material that is substantially the same as that of the first lower pattern 114a and the second lower pattern 118a. Alternatively, the first upper layer 124 and the second upper layer 128 may include a material that is different from that of the first lower pattern 114a and the second lower pattern 118a.

In some example embodiments, the second deformation-preventing layer pattern 126 may include a metal oxide, a silicon oxide, etc. The metal oxide may include Ta₂O₅, Ta₂O₅N, Al₂O₅, HfO₂, ZrO₂, TiO₂, SrO, etc. These may be used alone or in a combination thereof. The second deformation-preventing layer pattern 126 may have a thickness of about 3 Å to about 20 Å.

For example, the second deformation-preventing layer 126 may include a material that is substantially the same as that of the first deformation-preventing layer pattern 116a. Alternatively, the second deformation-preventing layer 126 may include a material that is different from that of the first deformation-preventing layer pattern 116a.

According to this example embodiment, the second deformation-preventing layer 126 may prevent structural deformation and electrical characteristic change of the first upper layer 124 and the second upper layer 128.

Therefore, the capacitor may include the dielectric layer having a high dielectric constant, the lower electrode structure having a high work function, and the upper electrode having a high work function. Further, the first deformation-preventing layer pattern and the second deformation-preventing layer may suppress the grain growth of the first lower pattern and the second lower pattern, and the first upper layer and the second upper layer, respectively. Thus, the capacitor may have a low leakage current and a high capacitance.

Hereinafter, a method of foiining the capacitor in FIG. 5 may be illustrated. Processes substantially the same as those illustrated with reference to FIGS. 2A to 2E may be performed to provide the structure in FIG. 2E.

The first upper layer 124 may be formed on the dielectric layer 122. In some example embodiments, the first upper layer 124 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof.

In some example embodiments, the first upper layer 124 may be formed by an ALD process, a CVD process, a PVD process, etc. In order to provide the first upper layer 124 with good step coverage, the first upper layer 124 may be formed by the ALD process.

The second deformation-preventing layer 126 may be formed on the first upper layer 124. In some example embodiments, the second deformation-preventing layer 126 may include a material that is substantially the same as that of the first deformation-preventing layer pattern 116a. Further, the second deformation-preventing layer pattern 126 may be formed by a process that is substantially the same as that of foiining the first deformation-preventing layer pattern 116a. The second deformation-preventing layer pattern 126 may have a thickness of about 3 Å to about 20 Å.

The second upper layer 128 may be formed on the second deformation-preventing layer 126 to complete the capacitor in FIG. 5. In some example embodiments, the second upper layer 128 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof.

In some example embodiments, the second upper layer 128 may be formed by an ALD process, a CVD process, a PVD process, etc. In order to provide the second upper layer 128 with good step coverage, the second upper layer 128 may be formed by the ALD process.

In some example embodiments, it may be difficult to form the first upper layer 124 and the second upper layer 128 having a thickness of greater than about 2,000 Å. Thus, the first upper layer 124 and the second upper layer 128 may have a thickness of no more than about 2,000 Å.

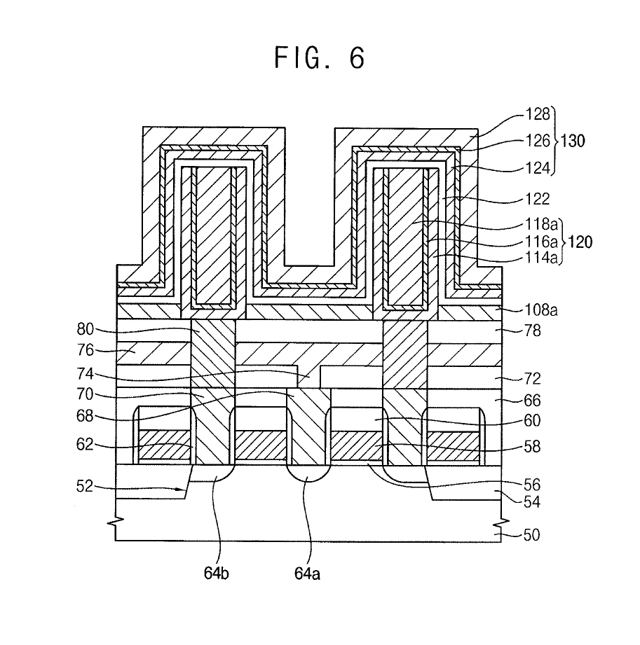

FIG. 6 illustrates a cross-sectional view relating to a DRAM device including the capacitor in FIG. 5.

Referring to FIG. 6, isolation layer patterns 54 may be formed in a semiconductor substrate 50 to define an active region and a field region of the semiconductor substrate 50. A MOS transistor may be formed on the semiconductor substrate 50.

A first insulating interlayer 66 may cover the MOS transistor. A first contact pad 68 and a second contact pad 70 may be formed through the first insulating interlayer 66. The first contact pad 68 and the second contact pad 70 may make contact with a first impurity region 64a and a second impurity region 64b of the MOS transistor, respectively.

A second insulating interlayer 72 may be formed on the first insulating interlayer 66. A bit line contact 74 may be formed through the second insulating interlayer 72. The bit line contact 74 may make contact with the first contact pad 64a. A bit line 76 may make contact with the bit line contact 74. The bit line 76 may extend in a second direction substantially perpendicular to the first direction. A hard mask pattern (not shown) may be formed on the bit line 76. A spacer (not shown) may be formed on a sidewall of the bit line 76.

A third insulating interlayer 78 may be formed on the second insulating interlayer 72 to cover the bit line 76. A storage node contact 80 may be formed through the third insulating interlayer 78 and the second insulating interlayer 72. The storage node contact 80 may make contact with the second contact pad 70.

An etch stop layer pattern 108a may be formed on the third insulating interlayer 78. The etch stop layer pattern 108a may have an opening configured to expose an upper surface of the storage node contact 80.

A lower electrode structure 120 may be formed on the storage node contact 80. The lower electrode structure 120 may include a first lower pattern 114a, a first deformation-preventing layer pattern 116a and a second lower pattern 118a. In some example embodiments, the lower electrode structure 120 may be substantially the same as the lower electrode structure 120 in FIG. 5.

A dielectric layer 122 may be formed on the lower electrode structure 120 and the etch stop layer pattern 108a. The dielectric layer 122 may be formed on an outer surface of the first lower pattern 114a, upper surfaces of the first lower pattern 114a, the second lower pattern 118a and the first deformation-preventing layer pattern 116a, and an upper surface of the etch stop layer pattern 108a. In some example embodiments, the dielectric layer 122 may have a structure substantially the same as that of the dielectric layer 122 in FIG. 5.

An upper electrode structure 130 may be formed on the dielectric layer 122. In some example embodiments, the upper electrode structure 130 may be substantially the same as the upper electrode structure 130 in FIG. 5. Thus, the upper electrode structure 130 may include the first upper layer 124, the second deformation-preventing layer 126 and the second upper layer 128.

Hereinafter, a method of manufacturing the DRAM device in FIG. 6 may be illustrated.

Processes substantially the same as those illustrated with reference to FIGS. 4A and 4B may be performed to form the structure in FIG. 4B. The etch stop layer pattern 108a may be formed on the third insulating interlayer 78. The capacitor may be formed on the storage node contact 80. In some example embodiments, the capacitor may be formed by processes substantially the same as those illustrated with reference to FIGS. 2A to 2E and FIG. 5. Thus, the capacitor may include the lower electrode structure 120, the dielectric layer 122 and the upper electrode structure 130. The lower electrode structure 120 may include the first lower pattern 114a, the first deformation-preventing layer pattern 116a and the second lower pattern 118a. The upper electrode structure 130 may include the first upper layer 124, the second deformation-preventing layer 126 and the second upper layer 128.

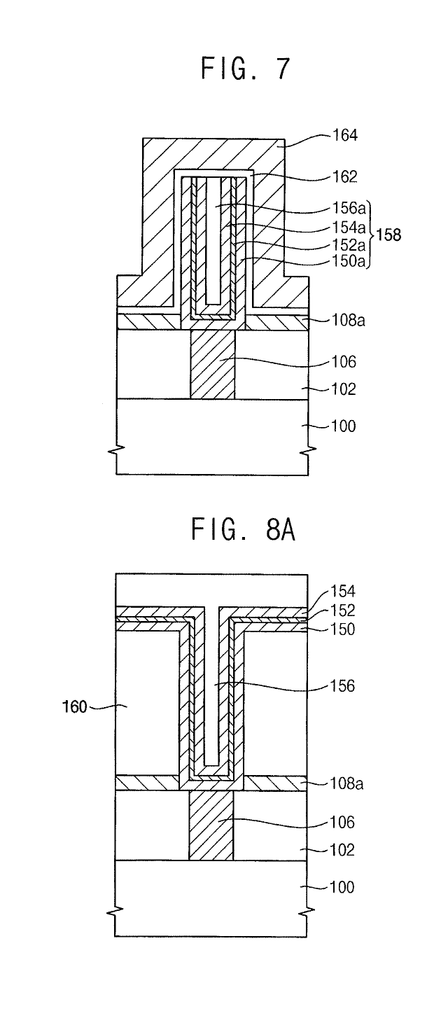

FIG. 7 illustrates a cross-sectional view relating to a capacitor in accordance with some example embodiments.

Referring to FIG. 7, an insulating interlayer 102 may be formed on an upper surface of a semiconductor substrate 100. A contact plug 106 may be formed through the insulating interlayer 102. The contact plug 106 may have a lower surface configured to make contact with the upper surface of the semiconductor substrate 100.

An etch stop layer pattern 108a may be formed on the insulating interlayer 102. In some example embodiments, the etch stop layer pattern 108a may have an opening configured to expose the upper surface of the contact plug 106.

A lower electrode structure 158 may be formed on the upper surface of the contact plug 106. In some example embodiments, the lower electrode structure 158 may include a first lower pattern 150a, a first deformation-preventing layer pattern 152a, a second lower pattern 154a and a buried layer pattern 156a. The first lower pattern 150a may include a hollow cylindrical-shaped portion and a closed lower end. The first deformation-preventing layer pattern 152a may be formed an inner surface of the first lower pattern 150a. The second lower pattern 154a may be formed on the first deformation-preventing layer pattern 152a. The buried layer pattern 156a may be formed on the second lower pattern 154a to fill up the cylindrical shape of the first lower pattern 150a. The buried layer pattern 156a may fill a space that remains in the hollow cylindrical-shaped portion of the first lower pattern 150a when the first deformation-preventing layer pattern 152a and the second lower pattern 154a are formed on the first lower pattern 150a. Thus, the lower electrode structure 158 may have a pillar shape. An outer surface of the first lower pattern 150a may be exposed. Upper surfaces of the first lower pattern 150a, the first deformation-preventing layer pattern 152a, the second lower pattern 154a and the buried layer pattern 156a may be exposed.

In some example embodiments, the first lower pattern 150a and the second lower pattern 154a may serve as a lower electrode of the capacitor. The first deformation-preventing layer pattern 152a may be configured to be interposed between the first lower pattern 150a and the second lower pattern 154a. The buried layer pattern 156a may fill the cylindrical shape to provide the lower electrode structure 120 with the pillar shape.

In some example embodiments, the first lower pattern 150a and the second lower pattern 154a may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. The first lower pattern 150a and the second lower pattern 154a may include substantially the same material. Alternatively, the first lower pattern 150a and the second lower pattern 154a may include different materials. The second lower pattern 154a may not fully fill the cylindrical shape. Thus, if the second lower pattern 154a is made of a relatively expensive material, forming the second lower pattern 154a to be thin may allow a cost for forming the capacitor to be reduced.

In some example embodiments, the buried layer pattern 156a may include a metal oxide, silicon oxide, etc. The metal oxide may include Ta₂O₅, Ta₂O₅N, TiO₂, etc. These may be used alone or in a combination thereof

A dielectric layer 162 may be formed on the lower electrode structure 158 and the etch stop layer pattern 108a. Particularly, the dielectric layer 162 may be formed on the outer surface of the first lower pattern 150a, the upper surfaces of the first lower pattern 150a, the second lower pattern 154a, the first deformation-preventing layer pattern 152a and the buried layer pattern 156a, and the upper surface of the etch stop layer pattern 108a. In some example embodiments, the dielectric layer 162 may include a metal oxide, non-conductive perovskite-type oxide, etc. For example, the metal oxide may include Ta₂O₅, Ta₂O₅N, Al₂O₅, HfO₂, ZrO₂, TiO₂, etc. The non-conductive perovskite-type oxide may include (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃, Bi₄Ti₃O₁₂, etc. These may be used alone or in a combination thereof.

An upper electrode 164 may be formed on the dielectric layer 162. In some example embodiments, the upper electrode 164 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc.

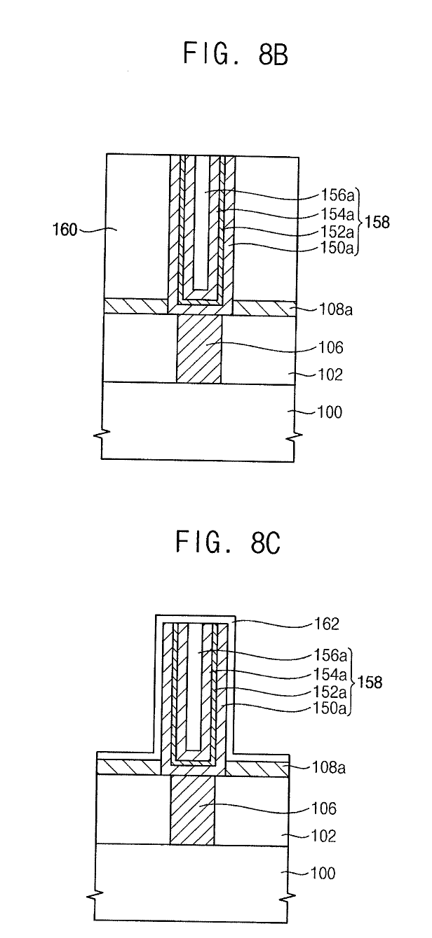

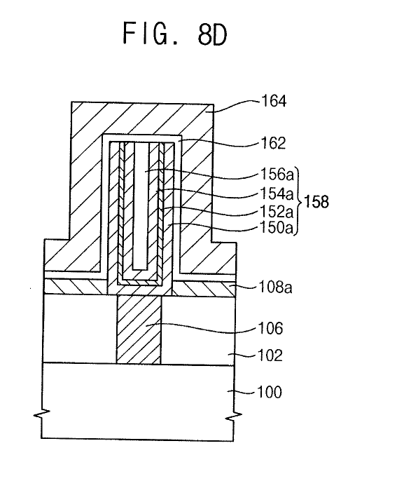

FIGS. 8A to 8D illustrate cross-sectional viewsrelating to a method of forming the capacitor in FIG. 7.

Processes that are substantially the same as those illustrated with reference to FIGS. 2A and 2B may be performed to form an insulating interlayer 120 and a contact plug 106 on a semiconductor substrate 100. An etch stop layer pattern 108a and a mold layer pattern 160 may be formed on the insulating interlayer 102.

Referring to FIG. 8A, a first conductive layer 150 may be formed on an inner surface of the opening and an upper surface of the mold layer pattern 160. In some example embodiments, the first conductive layer 150 may be converted into a first lower pattern by following processes. The first conductive layer 150 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof.

In some example embodiments, the first conductive layer 150 may be formed by an atomic layer deposition (ALD) process, a CVD process, a physical vapor deposition (PVD) process, etc. In order to provide the first conductive layer 150 with good step coverage, the first conductive layer 150 may be formed by the ALD process.

A first deformation-preventing layer 152 may be formed on the first conductive layer 150. In some example embodiments, the first deformation-preventing layer 152 may include a metal oxide, silicon oxide, etc. The metal oxide may include Ta₂O₅, Ta₂O₅N, Al₂O₅, HfO₂, ZrO₂, TiO₂, SrO, etc. These may be used alone or in a combination thereof. The first deformation-preventing layer 116 may have a thickness of about 3 Å to about 20 Å. In order to provide the first deformation-preventing layer 152 with good step coverage and a uniform thin thickness, the first deformation-preventing layer 152 may be formed by an ALD process or a CVD process.

A second conductive layer 154 may be formed on the first deformation-preventing layer 152. In some example embodiments, the second conductive layer 154 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof. The second conductive layer 152 may be formed by an ALD process, a CVD process, a PVD process, etc. In order to provide the second conductive layer 154 with good step coverage, the second conductive layer 154 may be formed by the ALD process. Here, the opening may not be fully filled with the second conductive layer 154. Thus, the second conductive layer 154 may have a thin thickness, so that a cost for forming the capacitor may be decreased.

A buried layer 156 may be formed on the second conductive layer 154 to fill up the opening. In some example embodiments, the buried layer 156 may include an insulating material. The buried layer 156 may include a metal oxide, silicon oxide, etc. The metal oxide may include Ta₂O₅, Ta₂O₅N, TiO₂, etc. These may be used alone or in a combination thereof. The buried layer 156 may include a material having a high etching selectivity with respect to the mold layer pattern 160 and capable of suppressing a grain growth of the second conductive layer 154.

Referring to FIG. 8B, the first conductive layer 150, the first deformation-preventing layer 152, the second conductive layer 154 and the buried layer 156 may be removed until an upper surface of the mold layer pattern 160 is exposed to form a lower electrode structure 158. The lower electrode 158 may include a first lower pattern 150a, a first deformation-preventing layer pattern 152a, a second lower pattern 154a and a buried layer pattern 156a. The first lower pattern 150a may include a hollow cylindrical-shaped portion and a closed lower end. The first deformation-preventing layer pattern 152a may be formed on an inner surface of the first lower pattern 150a. The second lower pattern 154a may be formed on the first deformation-preventing layer pattern 152a. The buried layer pattern 156a may be formed on the second lower pattern 154a to fill up the opening. Thus, the lower electrode structure 158 may have a pillar shape. In some example embodiments, the first conductive layer 150, the first deformation-preventing layer 152, the second conductive layer 154 and the buried layer 156 may be removed by a CMP process, en etch-back process, etc.

Referring to FIG. 8C, the mold layer pattern 160 may be removed to expose a surface of the lower electrode structure 158. In some example embodiments, the mold layer pattern 160 may be removed by a wet etching process to prevent the lower electrode structure 158 from being damaged by plasma.

A dielectric layer 162 may be formed on the lower electrode structure 158 and the etch stop layer pattern 108a. In some example embodiments, the dielectric layer 162 may include a metal oxide, non-conductive perovskite-type oxide, etc. For example, the metal oxide may include Ta₂O₅, Ta₂O₅N, Al₂O₅, HfO₂, ZrO₂, TiO₂, etc. The non-conductive perovskite-type oxide may include (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃, Bi₄Ti₃O₁₂, etc. These may be used alone or in a combination thereof. In some example embodiments, after forming the dielectric layer 162, the dielectric layer 162 may be thermally treated additionally to improve characteristics of the dielectric layer 162. The thermal treatment process may provide the dielectric layer 162 with a high dielectric constant.

Referring to FIG. 8D, an upper electrode 164 may be formed on the dielectric layer 162. In some example embodiments, the upper electrode 164 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc. These may be used alone or in a combination thereof.

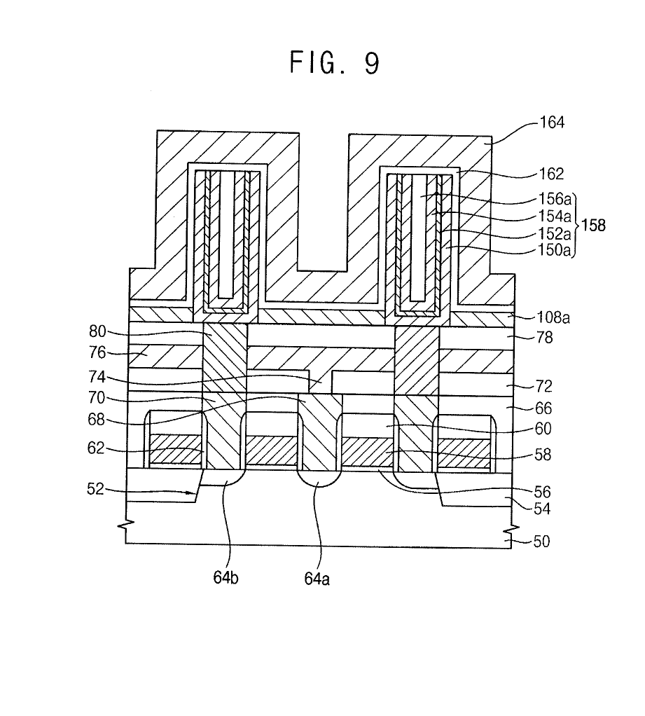

FIG. 9 illustrates a cross-sectional view relating to a DRAM device including the capacitor in FIG. 7.

Referring to FIG. 9, isolation layer patterns 54 may be formed in a semiconductor substrate 50 to define an active region and a field region of the semiconductor substrate 50. A MOS transistor may be formed on the semiconductor substrate 50.

A first insulating interlayer 66 may cover the MOS transistor. A first contact pad 68 and a second contact pad 70 may be formed through the first insulating interlayer 66. The first contact pad 68 and the second contact pad 70 may make contact with a first impurity region 64a and a second impurity region 64b of the MOS transistor, respectively.

A second insulating interlayer 72 may be formed on the first insulating interlayer 66. A bit line contact 74 may be formed through the second insulating interlayer 72. The bit line contact 74 may make contact with the first contact pad 64a. A bit line 76 may make contact with the bit line contact 74. The bit line 76 may extend in a second direction substantially perpendicular to the first direction. A hard mask pattern (not shown) may be formed on the bit line 76. A spacer (not shown) may be formed on a sidewall of the bit line 76.

A third insulating interlayer 78 may be formed on the second insulating interlayer 72 to cover the bit line 76. A storage node contact 80 may be formed through the third insulating interlayer 78 and the second insulating interlayer 72. The storage node contact 80 may make contact with the second contact pad 70.

An etch stop layer pattern 108a may be formed on the third insulating interlayer 78. The etch stop layer pattern 108a may have an opening configured to expose an upper surface of the storage node contact 80.

Processes substantially the same as those illustrated with reference to FIGS. 4A and 4B may be performed to form the structure illustrated in FIG. 4B. A capacitor substantially the same as the capacitor in FIG. 7 may be formed on the storage node contact 80. The capacitor may include a lower electrode structure 158, a dielectric layer 162 and an upper electrode 164. The lower electrode structure 158 may include a first lower pattern 150a, a first deformation-preventing layer pattern 152a, a second lower pattern 154a and a buried layer pattern 156a.

FIG. 10 illustrates a cross-sectional view relating to a capacitor in accordance with some example embodiments.

Referring to FIG. 10, an insulating interlayer 102 may be formed on an upper surface of a semiconductor substrate 100. A contact plug 106 may be formed through the insulating interlayer 102. The contact plug 106 may have a lower surface configured to make contact with the upper surface of the semiconductor substrate 100. An etch stop layer pattern 108a may be formed on the insulating interlayer 102. In some example embodiments, the etch stop layer pattern 108a may have an opening configured to expose the upper surface of the contact plug 106.

A lower electrode structure 158 may be formed on the upper surface of the contact plug 106. In some example embodiments, the lower electrode structure 158 may have a structure substantially the same as the lower electrode structure in FIG. 7. Thus, the lower electrode structure 158 may include a first lower pattern 150a, a first deformation-preventing layer pattern 152a, a second lower pattern 154a and a buried layer pattern 156a. The first lower pattern 150a may include a hollow cylindrical-shaped portion and a closed lower end. The first deformation-preventing layer pattern 152a may be formed an inner surface of the first lower pattern 150a. The second lower pattern 154a may be formed on the first deformation-preventing layer pattern 152a. The buried layer pattern 156a may be formed on the second lower pattern 154a to fill up the cylindrical shape of the first lower pattern 150a.

A dielectric layer 162 may be formed on the lower electrode structure 158 and the etch stop layer pattern 108a. Particularly, the dielectric layer 162 may be formed on the outer surface of the first lower pattern 150a, the upper surfaces of the first lower pattern 150a, the second lower pattern 154a, the first deformation-preventing layer pattern 152a and the buried layer pattern 156a, and the upper surface of the etch stop layer pattern 108a. In some example embodiments, the dielectric layer 162 may include a metal oxide, non-conductive perovskite-type oxide, etc. For example, the metal oxide may include Ta₂O₅, Ta₂O₅N, Al₂O₅, HfO₂, ZrO₂, TiO₂, etc. The non-conductive perovskite-type oxide may include (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃, Bi₄Ti₃O₁₂, etc. These may be used alone or in a combination thereof.

An upper electrode structure 178 may be formed on the dielectric layer 162. The upper electrode structure 162 may include a first upper layer 170, a second deformation-preventing layer 172, a second upper layer 174 and a capping layer 176.

In some example embodiments, the first upper layer 170 and the second upper layer 174 may include a noble metal, conductive noble oxide, conductive perovskite-type oxide, etc. For example, the noble metal may include Pt, Ru, Ir, etc. The conductive noble oxide may include PtO, RuO₂, IrO₂, etc. The conductive perovskite-type oxide may include SRO(SrRuO₃), BSRO((Ba,Sr)RuO₃), CRO(CaRuO₃), LSCO, etc.

In some example embodiments, the second deformation-preventing layer pattern 172 may include a metal oxide, silicon oxide, etc. The metal oxide may include Ta₂O₅, Ta₂O₅N, Al₂O₅, HfO₂, ZrO₂, TiO₂, SrO, etc. These may be used alone or in a combination thereof. The second deformation-preventing layer pattern 172 may have a thickness of about 3 Å to about 20 Å.

For example, the second deformation-preventing layer 172 may include a material that is substantially the same as that of the first deformation-preventing layer pattern 152a. Alternatively, the second deformation-preventing layer 172 may include a material that is different from that of the first deformation-preventing layer pattern 152a.

In some example embodiments, the capping layer 176 may include a metal oxide, silicon oxide, etc. The metal oxide may include Ta₂O₅, Ta₂O₅N, Al₂O₅, HfO₂, ZrO₂, TiO₂, SrO, etc. These may be used alone or in a combination thereof. The capping layer 176 may have a thickness of about 3 Å to about 100 Å. The capping layer 176 may suppress a grain growth of the second upper layer 174.

The upper electrode structure 178 may include the first upper layer 170, the second deformation-preventing layer 172 and the second upper layer 174. That is, the capping layer 176 may be omitted from the upper electrode structure 178.

Hereinafter, a method of forming the capacitor in FIG. 10 may be illustrated.

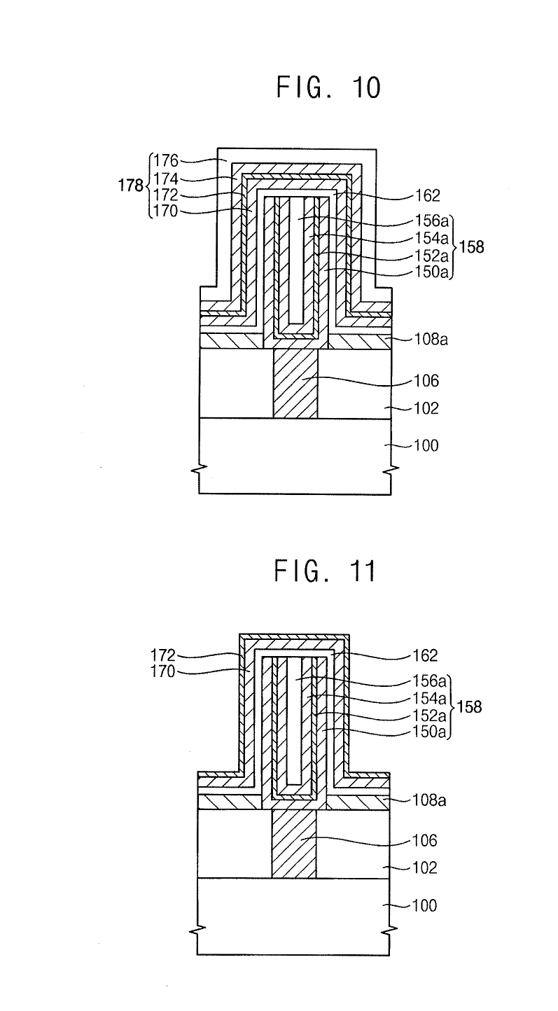

FIG. 11 illustrates a cross-sectional view relating to a method of forming the capacitor in FIG. 10.

Processes that are substantially the same as those illustrated with reference to FIGS. 8A to 8C may be performed to form the structure in FIG. 8C.

Referring to FIG. 11, the first upper layer 170 and the second deformation-preventing layer 172 may be sequentially formed on the dielectric layer 162.

The second upper layer 174 and the capping layer 176 may be sequentially formed on the second deformation-preventing layer 172 to complete the capacitor in FIG. 10.

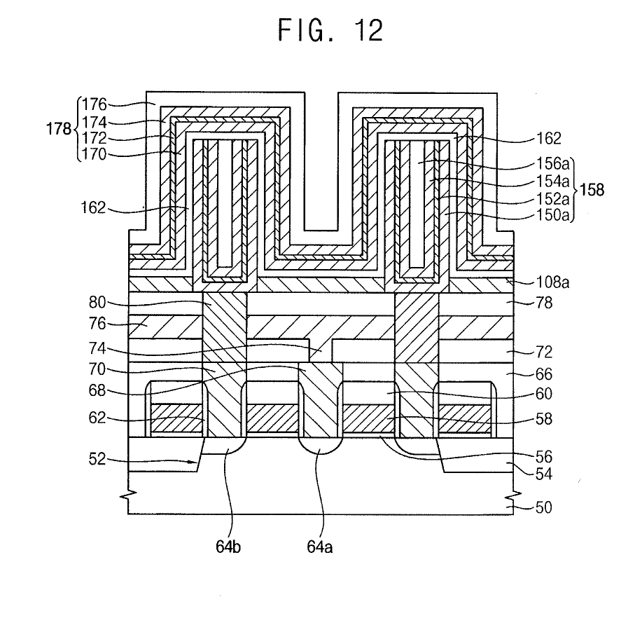

FIG. 12 illustrates a cross-sectional view relating to a DRAM device including the capacitor in FIG. 10.

Referring to FIG. 12, a MOS transistor may be formed on the semiconductor substrate 50. A first insulating interlayer 66 may cover the MOS transistor. A first contact pad 68 and a second contact pad 70 may be formed through the first insulating interlayer 66. The first contact pad 68 and the second contact pad 70 may make contact with a first impurity region 64a and a second impurity region 64b of the MOS transistor, respectively.

A second insulating interlayer 72 may be formed on the first insulating interlayer 66. A bit line contact 74 may be formed through the second insulating interlayer 72. The bit line contact 74 may make contact with the first contact pad 64a. A bit line 76 may make contact with the bit line contact 74. The bit line 76 may extend in a second direction substantially perpendicular to the first direction. A hard mask pattern (not shown) may be formed on the bit line 76. A spacer (not shown) may be formed on a sidewall of the bit line 76.

A third insulating interlayer 78 may be formed on the second insulating interlayer 72 to cover the bit line 76. A storage node contact 80 may be formed through the third insulating interlayer 78 and the second insulating interlayer 72. The storage node contact 80 may make contact with the second contact pad 70.

An etch stop layer pattern 108a may be formed on the third insulating interlayer 78. The etch stop layer pattern 108a may have an opening configured to expose an upper surface of the storage node contact 80.

A capacitor substantially the same as that in FIG. 10 may be formed on the storage node contact 80. The capacitor may include a lower electrode structure 158, a dielectric layer 162 and an upper electrode structure 178. The lower electrode structure 158 may include a first lower pattern 150a, a first deformation-preventing layer pattern 152a, a second lower pattern 154a and a buried layer pattern 156a. The first lower pattern 114a may include a hollow cylindrical-shaped portion and a closed lower end. The first deformation-preventing layer pattern 152a may be formed an inner surface of the first lower pattern 150a. The second lower pattern 154a may be formed on the first deformation-preventing layer pattern 152a. The buried layer pattern 156a may be formed on the second lower pattern 154a to fill up the cylindrical shape of the first lower pattern 150a. The upper electrode structure 178 may be formed on the dielectric layer 162. The upper electrode structure 162 may include a first upper layer 170, a second deformation-preventing layer 172, a second upper layer 174 and a capping layer 176.

Hereinafter, a method of manufacturing the DRAM device in FIG. 12 may be illustrated.

Processes substantially the same as those illustrated with reference to FIGS. 4A and 4B may be performed to form the structure in FIG. 4B. The etch stop layer pattern 108a may be formed on the third insulating interlayer 78. The capacitor may be formed on the storage node contact 80. In some example embodiments, the capacitor may have a structure substantially the same as that of the capacitor in FIG. 10. The capacitor may be formed by processes substantially the same as those illustrated with reference to FIGS. 10 and 11.

Here, semiconductor devices in accordance with some example embodiments may be applied to various electronic devices. For example, the DRAM device may be used in various memory devices such as a memory card, a USB memory, a solid-stage driver, etc.

FIGS. 13 to 15 illustrate block diagrams relating to memory systems in accordance with some example embodiments.

Referring to FIG. 13, a memory system of this example embodiment may include a memory 610 and a memory controller 620. The memory 610 may include DRAM devices in accordance with some example embodiments. The memory controller 620 may input a signal for controlling operations of the memory 610. For example, the memory controller 620 may input a command signal, an address signal, etc. The memory controller 620 may control the memory 610 in accordance with received control signals.

Referring to FIG. 14, a memory system of this example embodiment may include a memory 610 and an interface 615. The memory 610 may include DRAM devices in accordance with some example embodiments. The interface 615 may transmit an input signal from an exterior. For example, the interface 615 may transmit a command signal, an address signal, etc. The interface 615 may control the memory 610 in accordance with received control signals.

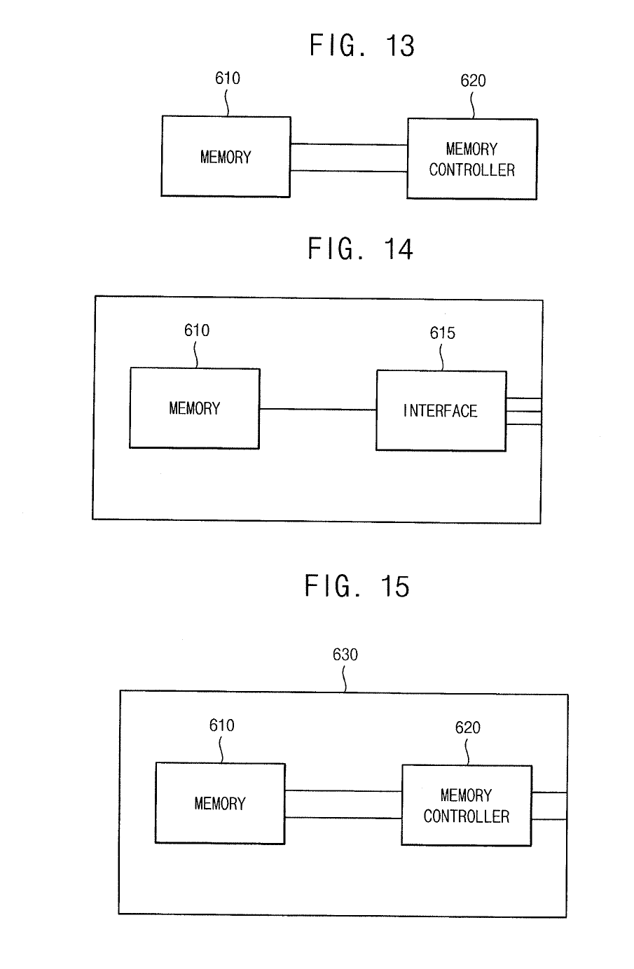

Referring to FIG. 15, a memory system of this example embodiment may correspond to a memory card 630 including a memory 610 and a memory controller 620. In some example embodiments, the memory card 630 may be used in a digital camera, a personal computer, etc. The memory controller 620 may control the memory 610 in accordance with received control signals.

By way of summation and review, as an area of a cell in a semiconductor device becomes reduced by a high integration of the semiconductor device, it may be difficult to form a capacitor having a high capacitance in the small area of the cell. In order to increase the capacitance of the capacitor, an oxidation-resistance metal may be used for an electrode of the capacitor. A formation of an undesired oxide layer on the oxidation-resistance metal may be suppressed, so that a dielectric layer may have a thin thickness.

The example embodiments may help to circumvent any condition in which grains of the metal in the electrode of the capacitor may grow due to the application of heat, thereby possibly deforming the electrode. The example embodiments may further help to circumvent any condition in which such a deformed electrode may collapse or lean, thereby causing an undesirable leakage current characteristic.

According to some example embodiments, the deformation-preventing layer pattern may suppress stresses, which may be caused by thermal budget, applied to the electrode structure. Thus, deforming, leaning or collapsing of the electrode structure may be avoided, so that electrical characteristics of the electrode structure may be still maintained.

According to these example embodiments, the capacitor may have a high capacitance and a low leakage current.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A capacitor comprising:
a lower electrode structure including a first lower pattern having a hollow cylindrical shape, a first deformation-preventing layer pattern formed on an inner surface of the first lower pattern and a second lower pattern formed on the first deformation-preventing layer pattern;
a dielectric layer formed on the lower electrode structure; and
an upper electrode structure formed on the dielectric layer.

2. The capacitor as claimed in claim 1, wherein the first lower pattern and the second lower pattern include at least one of a noble metal, conductive noble oxide and conductive perovskite-type oxide.

3. The capacitor as claimed in claim 2, wherein the first lower pattern and the second lower pattern include at least one of Pt, Ru, Ir, PtO, RuO₂, 1rO₂, SRO(SrRuO₃), BSRO((Ba,Sr)RuO₃), CRO(CaRuO₃) and LSCO.

4. The capacitor as claimed in claim 1, wherein the first deformation-preventing layer pattern has a thickness that is less than that of the dielectric layer.

5. The capacitor as claimed in claim 1, wherein the first deformation-preventing layer pattern has a thickness of about 3 Å to about 20 Å.

6. The capacitor as claimed in claim 1, wherein the first deformation-preventing layer pattern includes an insulating metal oxide or an insulating silicon oxide.

7. The capacitor as claimed in claim 6, wherein the first deformation-preventing layer pattern includes at least one of Ta₂O₅, Ta₂O₅N, Al₂O₅, HfO₂, ZrO₂, TiO₂ and SrO.

8. The capacitor as claimed in claim 1, wherein the upper electrode structure includes:
a first upper layer;
a second deformation-preventing layer formed on the first upper layer; and
a second upper layer formed on the second deformation-preventing layer.

9. The capacitor as claimed in claim 1, wherein the lower electrode structure further includes a buried layer pattern formed on the second lower pattern.

10. The capacitor as claimed in claim 1, wherein the dielectric layer includes at least one of a metal oxide and a non-conductive perovskite-type oxide.

11. The capacitor as claimed in claim 10, wherein the dielectric layer includes at least one of Ta₂O₅, Ta₂O₅N, Al₂O₅, HfO₂, ZrO₂, TiO₂, (Ba,Sr)TiO₃(BST), SrTiO₃(STO), BaTiO₃(BTO), PbTiO₃, Pb(Zr,Ti)O₃(PZT), SrBi₂Ta₂O₉(SBT), (Pb,La)(Zr,Ti)O₃ or Bi₄Ti₃^{O}₁₂.

12-20. (canceled)
